(19) United States
(12) Patent Application Publication
(10) Pub. No.: US 2011/0115798 A1
(43) Pub. Date: May 19, 2011

(54) METHODS AND SYSTEMS FOR CREATING SPEECH-ENABLED AVATARS

(76) Inventors: Shree K. Nayar, New York, NY (US); Dmitri Bitouk, New York, NY (US)

(21) Appl. No.: 12/599,523

(22) PCT Filed: May 9, 2008
(86) PCT No.: PCT/US08/63159

§ 371 Date: Jan. 24, 2011

Related U.S. Application Data
(60) Provisional application No. 60/928,615, filed on May 10, 2007.
(60) Provisional application No. 60/974,370, filed on Sep. 21, 2007.

(51) Int. Cl. G06T 13/00

(52) U.S. Cl. 345/473

(57) ABSTRACT

Methods and systems for creating speech-enabled as avatars are provided in accordance with some embodiments, methods for creating speech-enabled avatars are provided, the method comprising; receiving a single image that includes a face with distinct facial geometry; comparing points on the distinct facial geometry with corresponding points on a prototype facial surface, wherein the prototype facial surface is modeled by a Hidden Markov Model that has facial motion parameters; deforming the prototype facial surface based at least in part on the comparison; in response to receiving a text input or an audio input, calculating the facial motion parameters based on a phone set corresponding to the received input; generating a plurality of facial animations based on the calculated facial motion parameters and the Hidden Markov Model; and generating an avatar from the single image that includes the deformed facial sin face, the plurality of facial animations, and the audio input or an audio waveform corresponding to the text input.

### CROSS REFERENCE TO RELATED APPLICATION

This application claims the benefit of U.S. Provisional Patent Application No. 60/928,615, filed May 10, 2007 and U.S. Provisional Patent Application No. 60/974,370, filed Sep. 21, 2007, which are hereby incorporated by reference herein in their entireties.

### TECHNICAL FIELD

The disclosed subject matter relates to methods and systems for creating speech-enabled avatars.

### BACKGROUND

An avatar is a graphical representation of a user. For example, in video gaming systems or other virtual environments, a participant is represented to other participants in the form of an avatar that was previously created and stored by the participant.

There has been a growing need for developing human face avatars that appear realistic in terms of animation as well as appearance. The conventional solution is to map phonemes (the smallest phonetic unit in a language that is capable of conveying a distinction in meaning) to static mouth shapes. For example, animators in the film industry use motion capture technology to map an actor's performance to a computer-generated character.

This conventional solution, however, has several limitations. For example, mapping phonemes to static mouth shapes produces unrealistic, jerky facial animations. First, the facial motion often precedes the corresponding sounds. Second, particular facial articulations dominate the preceding as well as upcoming phonemes. In addition, such mapping requires a tedious amount of work by an animator. Thus, using the conventional solution, it is difficult to create an avatar that looks and sounds as if it was produced by a human face that is being recorded by a video camera.

Other image-based approaches typically use video sequences to build statistical models which relate temporal changes in the images at a pixel level to the sequence of phonemes uttered by the speaker. However, the quality of facial animations produced by such image-based approaches depends on the amount of video data that is available. In addition, image-based approaches cannot be employed for creating interactive avatars as they require a large training set of facial images in order to synthesize facial animations for each avatar.

There is therefore a need in the art for approaches that create speech-enabled avatars of faces that provide realistic facial motion from text or speech inputs. Accordingly, it is desirable to provide methods and systems that overcome these and other deficiencies of the prior art.

### SUMMARY

Methods and systems for creating speech-enabled avatars are provided. In accordance with some embodiments, methods for creating speech-enabled avatars are provided, the method comprising: receiving a single image that includes a face with a distinct facial geometry; comparing points on the distinct facial geometry with corresponding points on a prototype facial surface, wherein the prototype facial surface is modeled by a Hidden Markov Model that has facial motion parameters; deforming the prototype facial surface based at least in part on the comparison; in response to receiving a text input or an audio input, calculating the facial motion parameters based on a phone set corresponding to the received input; generating a plurality of facial animations based on the calculated facial motion parameters and the Hidden Markov Model; and generating an avatar from the single image that includes the deformed facial surface, the plurality of facial animations, and the audio input or an audio waveform corresponding to the text input.

### BRIEF DESCRIPTION OF THE DRAWINGS

FIG. 1 is a diagram of a mechanism for creating text-driven, two-dimensional, speech-enabled avatars in accordance with some embodiments.

FIGS. 2-4 are diagrams showing the deformation and/or morphing of a prototype facial surface onto the distinct facial geometry of a face from a received single image in accordance with some embodiments.

FIG. 5 is a diagram showing the animation of the prototype facial surface in response to basis vector fields in accordance with some embodiments.

FIG. 6 is a diagram showing eyeball textures synthesized from a portion of the received single image that can be used in connection with speech-enabled avatars in accordance with some embodiments.

FIG. 7 is a diagram showing the synthesis of eyeball gazes and/or eyeball motion that can be used in connection with speech-enabled avatars in accordance with some embodiments.

FIG. 8 is a diagram showing an example of a two-dimensional speech-enabled avatar in accordance with some embodiments.

FIG. 9 is a diagram of a mechanism for creating speech-driven, two-dimensional, speech-enabled avatars in accordance with some embodiments.

FIGS. 10 and 11 are diagrams showing the Hidden Markov Model topology that includes Hidden Markov Model states and transition probabilities for visual speech in accordance with some embodiments.

FIGS. 12 and 13 are diagrams showing the deformation of the prototype facial surface in response to changing facial motion parameters in accordance with some embodiments.

FIG. 14 is a diagram showing an example of a stereo image captured using an image acquisition device and a planar mirror in accordance with some embodiments.

FIG. 15 is a diagram showing the use of corresponding points to deform and/or morph a prototype facial surface onto the distinct facial geometry of a face from a stereo image in accordance with some embodiments.

FIG. 16 is a diagram showing an example of a static facial surface etched into a solid glass block using sub-surface laser engraving technology in accordance with some embodiments.

FIG. 17 is a diagram showing examples of facial animations at different points in time that are projected onto the static facial surface etched into a solid glass block in accordance with some embodiments.

### DETAILED DESCRIPTION

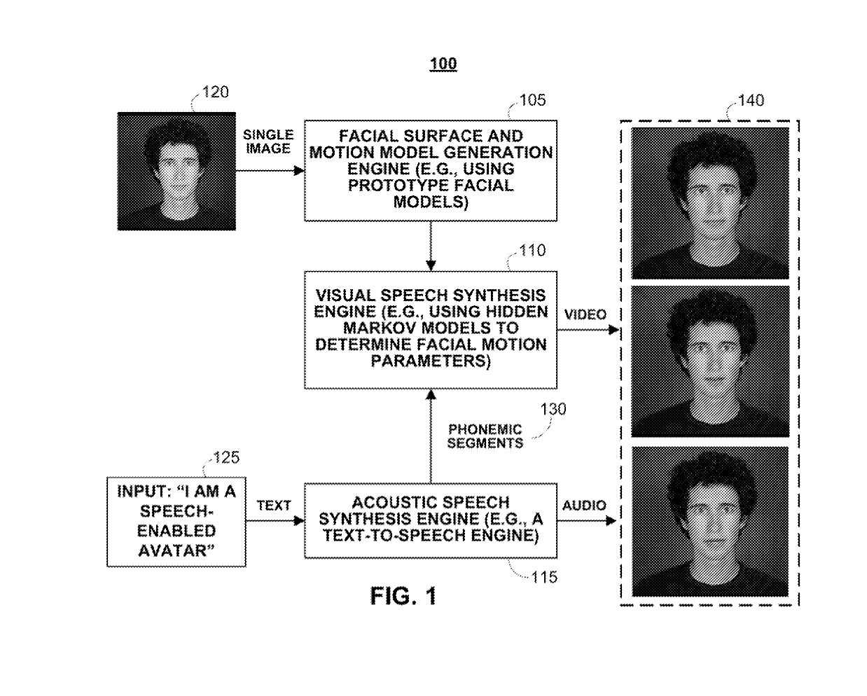

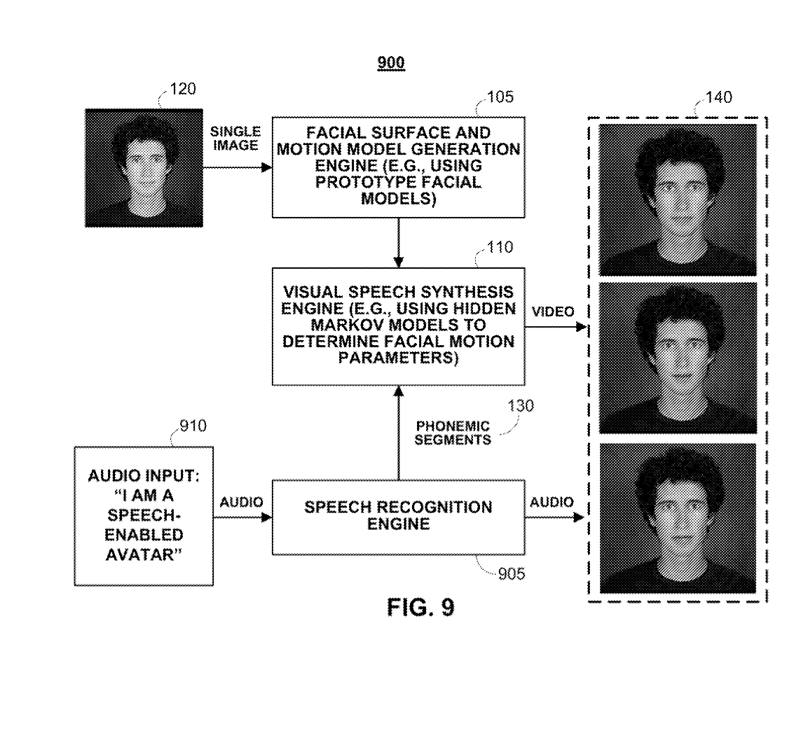

In accordance with various embodiments, mechanisms for creating speech-enabled avatars are provided. In some embodiments, methods and systems for creating text-driven, two-dimensional, speech-enabled avatars that provide realistic facial motion from a single image, such as the approach shown in FIG. 1, are provided. In some embodiments, methods and systems for creating speech-driven, two-dimensional, speech-enabled avatars that provide realistic facial motion from a single image, such as the approach shown in FIG. 9, are provided. In some embodiments, methods and systems for creating three-dimensional, speech-enabled avatars that provide realistic facial motion from a stereo image are provided.

In some embodiments, these mechanisms can receive a single image (or a portion of an image). For example, a single image (e.g., a photograph, a stereo image, etc.) can be an image of a person having a neutral express on the person's face, an image of a person's face received by an image acquisition device, or any other suitable image. A generic facial motion model is used that represents deformations of a prototype facial surface. These mechanisms transform the generic facial motion model to a distinct facial geometry (e.g., the facial geometry or the person's face in the single image) by comparing corresponding points between the face in the single image to the prototype facial surface. The prototype facial surface can be deformed and/or morphed to fit the face in the single image. For example, the prototype facial surface and basis vector fields associated with the prototype surface can be morphed to form a distinct facial surface corresponding to the face in the single image.

It should be noted that a Hidden Markov Model (sometimes referred to herein as an “HMM”) having facial motion parameters is associated with the prototype facial surface. The Hidden Markov Model can be trained using a training set of facial motion parameters obtained from motion capture data of a speaker. The Hidden Markov Model can also be trained to account for lexical stress and co-articulation. Using the trained Hidden Markov Model, the mechanisms are capable of producing realistic animations of the facial surface in response to receiving text, speech, or any other suitable input. For example, in response to receiving inputted text, a time-aligned sequence of phonemes is generated using an acoustic text-to-speech engine of the mechanisms or any other suitable acoustic speech engine. In another example, in response to receiving acoustic speech input, the time labels of the phones are generated using a speech recognition engine. The phone sequence is used to synthesize the facial motion parameters of the trained Hidden Markov Model. Accordingly, in response to receiving a single image along with inputted text or acoustic speech, the mechanisms can generate a speech-enabled avatar with realistic facial motion.

It should be noted that these mechanisms can be used in a variety of applications. For example, speech-enabled avatars can significantly enhance a user's experience in a variety of applications including mobile messaging, information kiosks, advertising, news reporting and videoconferencing.

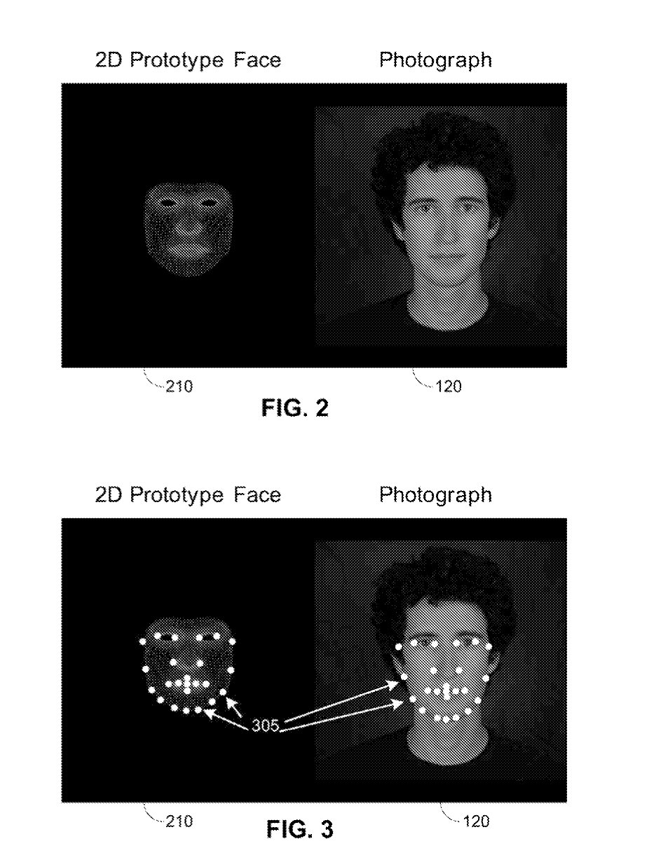

FIG. 1 shows a schematic diagram of a system 100 for creating a text-driven, two-dimensional, speech-enabled avatar from a single image in accordance with some embodiments. As can be seen in FIG. 1, the system includes a facial surface and motion model generation engine 105, a visual speech synthesis engine 110, and an acoustic speech synthesis engine 115. Facial surface and motion model generation engine 105 receives a single image 120. Single image 120 can be an image acquired by a still or video camera or any other suitable image acquisition device (e.g., a photograph acquired by a digital camera), or any other suitable image. One example of a photograph that can be used in some embodiments as single image of FIG. 1 is illustrated in FIGS. 2 and 3. As shown, photograph 210 was obtained using an image acquisition device, where the photograph is taken of a person looking at the image acquisition device with a neutral facial expression.

It should be noted that, in some embodiments, an image acquisition device (e.g., a digital camera, a digital video camera, etc.) may be connected to system 100. For example, in response to acquiring an image using an image acquisition device, the image acquisition device may transmit the image to system 100 to create a two-dimensional, speech-enabled avatar using that image. In another example, system 100 may access the image acquisition device and retrieve an image for creating a speech-enabled avatar. Alternatively, engine 105 can receive single image 120 using any suitable approach (e.g., the single image 120 is uploaded by a user, the single image 120 is obtained by accessing another processing device, etc.).

In response to receiving image 120, facial surface and motion model generation engine 105 compares image 120 with a prototype face surface 210. Because depth information generally cannot be recovered from image 120 or any other suitable photograph, facial surface and motion model generation engine 105 generates a reduced two-dimensional representation. For example, in some embodiments, engine 105 can flatten prototype face surface 210 using orthogonal projection onto the canonical frontal view plane. In such a reduced representation, the speech-enabled avatar is a two-dimensional surface with facial motions that are restricted to the plane of the avatar.

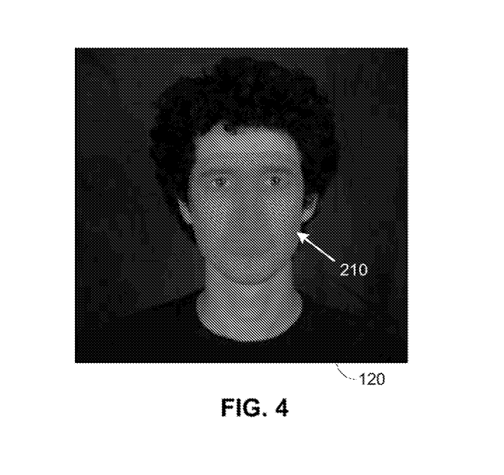

As shown in FIG. 3, to create the reduced two-dimensional representation, engine 105 establishes a correspondence between prototype face surface 210 and image 120 using corresponding points 305. A number of feature points are selected on image 120 and the corresponding points are selected on prototype face surface 210. For example, corresponding points 305 can be manually placed by the user of system 100. In another example, corresponding points 305 can be automatically designed by engine 105 or any other suitable component of system 100. Using the set of corresponding points 305, engine 105 deforms and/or morphs prototype face surface 210 to fit the corresponding points 305 selected on image 120. One example of the deformation of prototype face surface 210 is shown in FIG. 4.

It should be noted that engine 105 uses a generic facial motion model to describe the deformations of the prototype face surface 210. In some embodiments, the geometry of prototype face surface 210 can be represented by a parametrized surface:

x(u),xε [symbol] ,uε

[symbol]

The deformed prototype face surface 210 x(u) at the moment of time I during speech can be described using the following low-dimensional parametric model:

$${x}_{t} ( u ) = \overline{x} ( u ) + {\sum }_{k = 1}^{N} {α}_{k , t} {ψ}_{k} ( u ) .$$

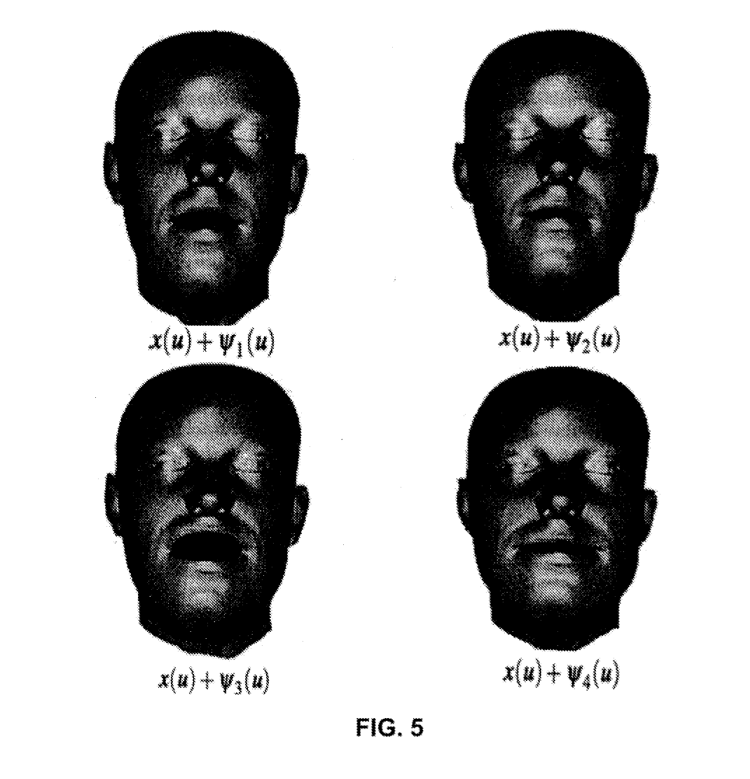

Vector fields ψₖ(u) which are defined on the face surface x(u) describe the principal modes of facial motion and are shown in FIG. 5. In some embodiments, the basis vector fields ψₖ(u) can be learned from a set of motion capture data. At each moment in time, the deformation of prototype facial surface 210 is described by a vector of facial motion parameters:

αₜ=(α_{1,t},α_{2,t}, . . . , α_{N,t})⁷

In this example, the dimensionality of the facial motion model is chosen to be N=9.

Engine 105 transforms the generic facial motion model to fit a distinct facial geometry (e.g., the facial geometry of the person's face in single image 120) by comparing corresponding points 305 between the face in single image 120 and prototype face surface 210. For example, basis vector fields are defined with the respect to prototype face surface 210 and engine 105 adjusts the basis vector fields to match the shape and geometry of a distinct face in single image 120. To map the generic facial motion model using corresponding points 305 between the prototype face surface 210 and the geometry of the face in single image 120, engine 105 can perform a shape analysis using diffeomorphisms φ: [symbol] [symbol] [symbol] defined as continuous one-to-one mappings of [symbol] with continuously differentiable inverses. A diffeomorphism φ that transforms the source surface x^{(s)}(u) into the target surface x^{(t)}(u) can be determined using one or more of the corresponding points 305 between the two surfaces.

It should be noted that the diffeomorphism φ that carries the source surface into the target surface defines a non-rigid coordinate transformation of the embedding Euclidean space. Accordingly, the action of the diffeomorphism φ on the basis vector fields ψₖ^{(s)} on the source surface can be defined by the Jacobian of φ:

ψₖ^{(s)}(u) [symbol] Dφ|ₓ_{^{(s)}}₍ᵤ_{ᵢ}₎·ψₖ^{(s)}(u),

where Dφ|ₓ_{^{(s)}}₍ᵤ_{ᵢ}₎ is the Jacobian of φ evaluated at the point x^{(s)}(uᵢ)

$${( D φ )}_{ij} = \frac{\partial {φ}_{i}}{\partial {x}_{j}} , i , j = 1 , 2 , 3.$$

Engine 105 uses the above-identified equation to adapt the generic facial motion model to the geometry of the face in image 120. Given the corresponding points 305 on the prototype face surface 210 and the image 120, engine can determine the diffeomorphism φ between them.

In some embodiments, engine 105 estimates the deformation between prototype face surface 210 and image 120. First, before engine 105 compares the data values between prototype face surface 210 and image 120, engine 105 aligns the prototype face surface 210 and the image 120 using rigid registration. For example, engine 105 rigidly aligns the data sets such that the shapes of prototype face surface 210 and image 120 are as close to each other as possible while keeping the prototype face surface 210 and image 120 unchanged. Using the corresponding points 305 (e.g., x₁^{(s)}, x₂^{(s)}, . . . , x_{Np}^{(s)}) on prototype face surface 210 and the corresponding points 305 (e.g., x₁^{(t)}, x₂^{(t)}, . . . , x_{Np}^{(t)}) on the aligned face in image 120, the diffeomorphism is given by:

$$φ ( x ) = x + {\sum }_{k = 1}^{{N}_{p}} K ( x , {x}_{k}^{( s )} ) {β}_{k}$$

where the kernel K(x,y) can be:

$$K ( x , y ) ∝ exp ( - \frac{{‖ x - y ‖}^{2}}{2 {σ}^{2}} ) {I}_{3 \times 3} .$$

and βₖε [symbol] are coefficients found by solving a system of linear equations.

For a diffeomorphism φ that carries the source surface x̅^{(s)}(u) into the targ α̅^{(t)}(u), φ(x^{(s)}(u))=φ(x^{(t)}(u)), it should be noted that the adaptation transfers the basis vector fields ψₖ^{(s)}(u) into the vector fields ψₖ^{(t)}(u) on the target surface such that the parameters αₖ are invariant to difference in shape and proportions between the two surfaces which are described by the diffeomorphism φ:

$$φ ( {\overline{x}}^{( s )} ( u ) + {\sum }_{k = 1}^{N} {α}_{k , t} {ψ}_{k}^{s} ( u ) ) = {\overline{x}}^{( t )} ( u ) + {\sum }_{k = 1}^{N} {α}_{k , t} {ψ}_{k}^{t} ( u ) .$$

In response to approximating the left-hand side of the above-equation using a Taylor series up to the first order term yields:

$${φ ( {\overline{x}}^{( s )} ( u ) ) + {\sum }_{k = 1}^{N} {α}_{k , t} D φ \vert}_{{x}^{( s )} ( {u}_{i} )} \cdot {ψ}_{k}^{s} ( u ) \approx {\overline{x}}^{( t )} ( u ) + {\sum }_{k = 1}^{N} {α}_{k , t} {ψ}_{k}^{t} ( u ) .$$

As the above-identified equation holds for small values of αₜ, the basis vector fields adapted to the target surface are given by:

ψₖ^{(t)}(u)=Dφ|ₓ_{^{(s)}}₍ᵤ_{ᵢ}₎·ψₖ^{(s)}(u).

The Jacobian Dφ can be computed by engine 105 using the above-mentioned equation at any point on the prototype surface 210 and applied to the facial motion basis vector fields in order to obtain the adapted basis vector fields:

$${( D φ )}_{ij} = \frac{\partial {φ}_{i}}{\partial {x}_{j}} , i , j = 1 , 2 , 3.$$

Alternatively, any other suitable approach for modeling prototype face surface 210 and/or image 120 can also be used. For example, in some embodiments, facial motion parameters (e.g., motion vectors) can be associated with prototype surface 210. Such facial motion parameters can be transferred from prototype face surface 210 to the face surface in image 120, thereby creating a surface with distinct geometric proportions. In another example, facial motion parameters can be associated with both prototype surface 210 and the face surface in image 120. The facial motion parameters of prototype surface 210 can be adjusted to match the facial motion parameters of the face surface in image 120.

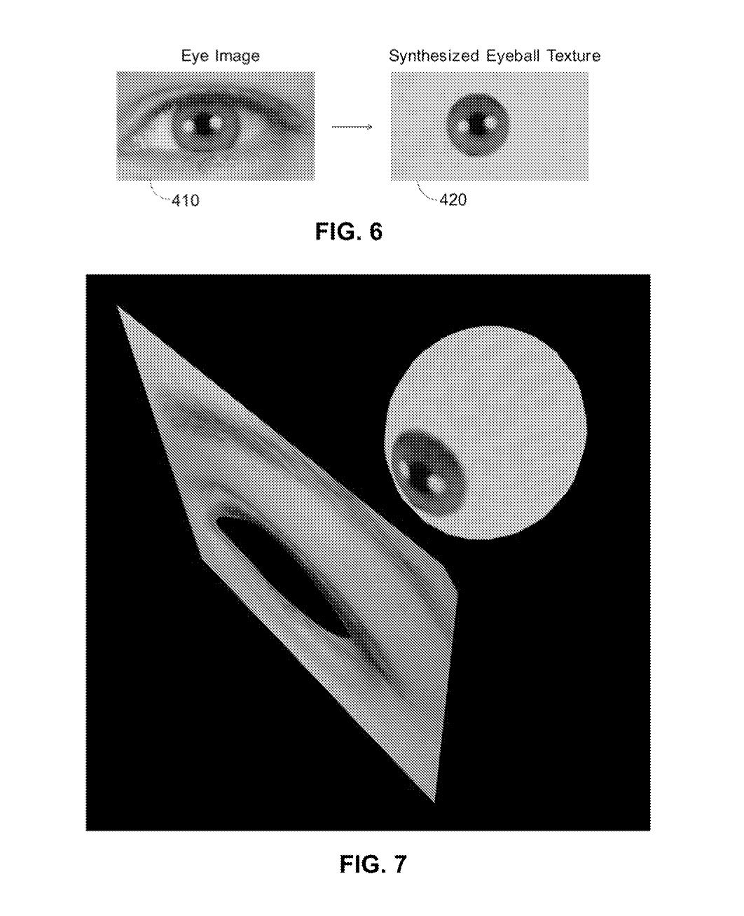

In some embodiments, face surface and motion model generation engine 105 generates eye textures and synthesizes eye gaze or eye motions (e.g., blinking) by the speech-enabled avatar. Such changes in eye gaze direction and eye motion can provide a compelling life-life appearance to the speech-enabled avatar. FIG. 6 shows an enlarged image 410 of the eye from image 120 and a synthesized eyeball image 420. As shown, enlarged image 410 includes regions that are obstructed by the eyelids, eyelashes, and/or other objects in image 120. Engine 105 creates synthesized eyeball image 420 by synthesizing or filling in the missing parts of the cornea and the sclera. For example, engine 105 can extract a portion of image 120 of FIGS. 1-3 that includes the eyeballs. Engine 105 can then determine the position and shape of the iris using generalized Hough transform, which segments the eye region into the iris and the sclera. Engine 105 creates image 420 by synthesizing the missing texture inside the iris and sclera image regions.

In some embodiments, face surface and motion model generation engine 105 synthesizes eye blinks to create a more realistic speech-enabled avatar. For example, engine 105 can use the blend shape approach, where the eye blink motion of prototype face model 210 is generated as a linear interpolation between the eyelid in the open position and the eyelid in the closed position.

It should be noted that, in some embodiments, engine 105 models each eyeball after a textured sphere that is placed behind an eyeless face surface. An example of this model is shown in FIG. 7. The eye gaze motion is generated by rotating the eyeball around its center. However, engine 105 can use any suitable model for synthesizing eye gaze and/or eye motions.

In some embodiments, face surface and motion model generation engine 105 or any other suitable component of the system can provide textured teeth and/or head motions to the speech-enabled avatar.

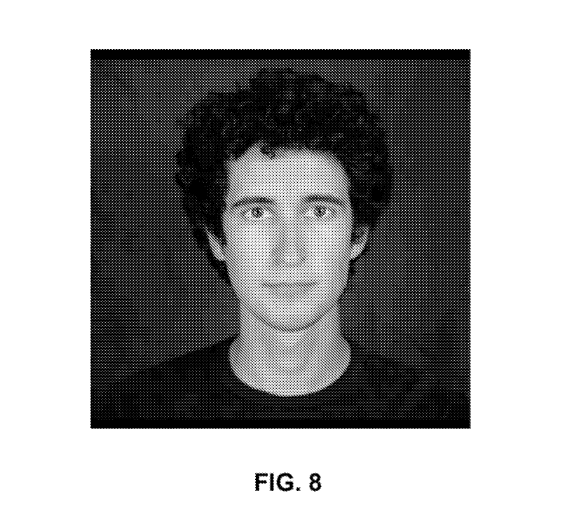

In response to adapting the prototype face surface 210 and the generic facial motion model to the face in image 120 and/or synthesizing eye motion, a two-dimensional animated avatar is created. FIG. 8 is an illustrated example of a two-dimensional, speech-enabled avatar in accordance with some embodiments. System 100 subsequently employs the obtained deformation to transfer the generic motion model onto the resulting prototype face surface 210. In addition, system 100 uses the obtained deformation mapping to transfer the facial motion model onto a novel subject's mesh (e.g., the prototype fitted onto the face of image 120). For example, as described further below, system 100 modifies the facial motion parameters based on received text or acoustic speech signals to synthesize facial animation (e.g., facial expressions).

Referring back to FIG. 1, in response to receiving inputted text 125 from a user, acoustic speech synthesis engine 115 of system 100 uses the text 125 to generate a waveform (e.g., an audio signal) and a sequence of phones 130. For example, in response to receiving the text “I am a speech-enabled avatar,” engine 115 generates an audio waveform that corresponds to the text “I am a speech-enabled avatar” and generates a sequence of phones synthesized along with their corresponding start and end times that corresponds to the received text. The sequence of phones 130 and any other associated information (e.g., timing information) is transmitted to the visual speech synthesis engine 110.

Alternatively, as shown in FIG. 9, methods and systems for creating speech-driven, two-dimensional, speech-enabled avatars that provide realistic facial motion from a single image are provided. As shown, system 900 includes a speech recognition engine 905 that receives acoustic speech signals. In response to receiving speech signals or any other suitable audio input 910 (e.g., “I am a speech-enabled avatar”), speech recognition engine 905 obtains the time-labels of the phones. For example, in some embodiments, speech recognition engine 905 uses a forced alignment procedure to obtain time-labels of the phones in the best hypothesis generated by speech recognition engine 905. Similar to the acoustic speech synthesis engine 115 of FIG. 1, the time-labels of the phones and any other associated information is transmitted to the visual speech synthesis engine 110.

It should be noted that, in speech applications, uttered words include phones, which are acoustic realizations of phonemes. System 100 can use any suitable phone set or any suitable list of distinct phones or speech sounds that engine 115 can recognize. For example, system 100 can use the Carnegie Mellon University (CMU) SPHINX phone set, which includes thirty-nine distinct phones and includes a non-speech unit (/SIL/) that describes inter-word silence intervals.

In some embodiments, in order to accommodate for lexical stress, system 100 can clone particular phonemes into stressed and unstressed phones. For example, system 100 can generate and/or supplement the most common vowel phonemes in the phone set into stressed and unstressed phones (e.g., /AA0/ and /AA1/). In another example, system 100 can also generate and/or supplement the phone set with both stressed and unstressed variants of phones /AA/, /AE/, /AH/, /AO/, /AY/, /EH/, /ER/, /EY/, /IH/, /IY/, /OW/, and /UW/ to accommodate for lexical stress. Alternatively, the rest of the vowels in the phone set can be modeled independent of their lexical stress.

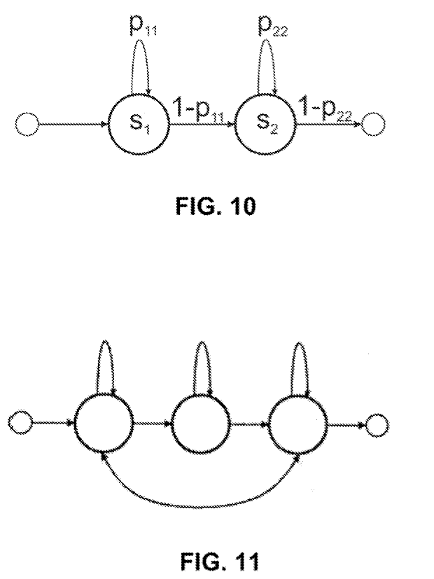

As shown in FIGS. 10 and 11, each of the phones, including stressed and unstressed variants, is generally represented as a 2-state Hidden Markov Model, while the /SIL/ unit is generally represented as a 3-state HMM topology. The Hidden Markov Model states (s₁ and s₂) represent an onset and end of the corresponding phone. As also shown in FIGS. 10 and 11 , the output probability of each Hidden Markov Model state is approximated with a Gaussian distribution over the facial parameters αₜ, which correspond to the Hidden Markov Model observations.

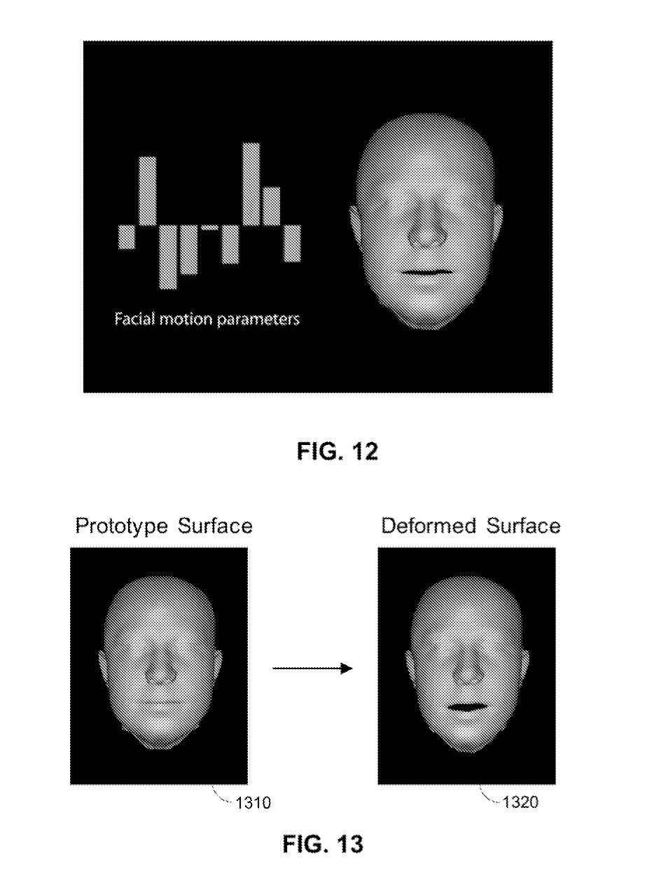

Referring back to FIG. 1, phone set 130 is transmitted from acoustic speech synthesis engine 115 (e.g., a text-to-speech engine) (FIG. 1) or from speech recognition engine 905 (FIG. 9) to visual speech synthesis engine 110. Engine 110 converts the time-labeled phone sequence and any other suitable information relating to the phone set to an ordered set of Hidden Markov Model states. More particularly, engine 110 uses the phone set to synthesize the facial motion parameters of the trained Hidden Markov Model. As shown in FIGS. 12 and 13 and described herein, the deformation of the prototype facial surface is described by the facial motion parameters. Using the timing information from acoustic synthesis engine 115 or from speech recognition engine 905 along with the facial motion parameters, visual speech synthesis engine 110 can create a facial animation for each instant of time (e.g., a deformed surface 1320 from prototype surface 1310 of FIG. 13). Accordingly, a two-dimensional, speech-enabled avatar with realistic facial motion from a single image can be created.

It should be noted that, in some embodiments, engine 110 trains a set of Hidden Markov Models using the facial motion parameters obtained from a training set of motion capture data of a single speaker. Engine 110 then utilizes the trained Hidden Markov Models to generate facial motion parameters from either text or speech input, which are subsequently employed to produce realistic animations of an avatar (e.g., avatar 140 of FIG. 1).

By training Hidden Markov Models, system 100 can obtain maximum likelihood estimates of the transition probabilities between Hidden Markov Model states and the sufficient statistics of the output probability densities for each Hidden Markov Model state from a set of observed facial motion parameter trajectories αₜ, which corresponds to the known sequence of words uttered by a speaker. For example, facial motion parameter trajectories derived from the motion capture data can be used as a training set. In order to account for the dynamic nature of visual speech, the original facial motion parameters αₜ, can be supplemented with the first derivative of the facial motion parameters and the second derivative of the facial motion parameters. For example, trained Hidden Markov Models can be based on the Baum-Welch algorithm, a generalized expectation-maximization algorithm that can determine maximum likelihood estimates for the parameters (e.g., facial motion parameters) of a Hidden Markov Model.

In some embodiments, a set of monophone Hidden Markov Models is trained. In order to capture co-articulation effects, monophone models are cloned into triphone HMMs to account for left and right neighboring phones. A decision-tree based clustering of triphone states can then by applied to improve the robustness of the estimated Hidden Markov Model parameters and predict triphones unseen in the training set.

It should be noted that the training set or training data includes facial motion parameter trajectories αₜ, and the corresponding word-level transcriptions. A dictionary can also be used to provide two instances of phone-level transcriptions for each of the words—e.g., the original transcription and a variant which ends with the silence unit /SIL/. The output probability densities of monophone Hidden Markov Model states can be initialized as a Gaussian density with mean and covariance equal to the global mean and covariance of the training data. Subsequently, multiple iterations (e.g., six) of the Baum-Welch algorithm are performed in order to refine the Hidden Markov Model parameter estimates using transcriptions which contain the silence unit only at the beginning and the end of each utterance. In addition, in some embodiments, a forced alignment procedure can be applied to obtain hypothesized pronunciations of each utterance in the training set. The final monophone Hidden Markov Models are constructed by performing multiple iterations (e.g., two) of the Baum-Welch algorithm.

In order to capture the effects of co-articulation, the obtained monophone Hidden Markov Models can be refined into triphone models to account for the preceding and the following phones. The triphone Hidden Markov Models can be initialized by cloning the corresponding monophone models and are consequently refined by performing multiple iterations (e.g., two) of the Baum-Welch algorithm. The triphone state models can be clustered with the help of a tree-based procedure to reduce the dimensionality of the model and construct models for triphones unseen in the training set. The resulting models are sometimes referred to as tied-state triphone HMMs in which the means and variances are constrained to be the same for triphone states belonging to a given cluster. The final set of tied-state triphone HMMs is obtained by applying another two iterations of the Baum-Welch algorithm.

As described previously, engine 110 uses the trained Hidden Markov Models to generate facial motion parameters from either text or speech input, which are subsequently employed to produce realistic animations of an avatar. For example, engine 110 converts the time-labeled phone sequence to an ordered set of context-dependent HMM states. Vowels can be substituted with their lexical stress variants according to the most likely pronunciation chosen from the dictionary with the help of a monogram language model. A Hidden Markov Model chain for the whole utterance can be created by concatenating clustered Hidden Markov Models of each triphone state from the decision tree constructed during the training stage. The resulting sequence consists of triphones and their start and end times.

It should be noted that the mean durations of the Hidden Markov Model states s₁ and s₂ with transition probabilities, as shown in FIG. 10, can be computed as p₁₁/(1−p₁₁) and p₂₂/(1−p₂₂). If the duration of a triphone n described by a 2-state Hidden Markov Model in the phone-level segmentation is t_{N}, the durations tₙ⁽¹⁾ and tₙ⁽²⁾ of its Hidden Markov Model states are proportional to their mean durations and are given by:

$${t}_{n}^{( 1 )} = \frac{{p}_{11} - {p}_{11} {p}_{22}}{{p}_{11} + {p}_{22} - {p}_{11} {p}_{22}} {t}_{n} , {t}_{n}^{( 2 )} = \frac{{p}_{22} - {p}_{11} {p}_{22}}{{p}_{11} + {p}_{22} - {p}_{11} {p}_{22}} {t}_{n}$$

Using the above-identified equation, engine 110 obtains the time-labeled sequence of triphone
HMM states s⁽¹⁾, s⁽²⁾, . . . , s^{(Ns)} from the phone-level segmentation.

In some embodiments, smooth trajectories of facial motion parameters \hat{α}₁=(α⁽¹⁾, . . . ,α^{(N}^{_{P}}⁾ corresponding to the above sequence of Hidden Markov Model states can be generated using a variational spline approach. For example, if N_{F} is the number of frames in an utterance, t₁, t₂, . . . , t_{NF} represents the centers of each frame, and sₜ₁, sₜ₂, . . . , s_{tNF}: represents the sequence of Hidden Markov Model states corresponding to each frame, the values of the facial motion parameters at the moments of time t₁, t₂, . . . , t_{NF} can be determined by the mean μₜ₁, μₜ₂, . . . , μ_{tNF} and diagonal covariance matrices Σₜ₁, Σₜ₂, . . . , Σ_{tNF} of the corresponding Hidden Markov Model state output probability densities. The vector components of a smooth trajectory of facial motion parameters can be described as:

$${\hat{α}}_{t}^{( k )} = {arg min}_{{α}_{t}^{( k )}} {\sum }_{n = 1}^{{N}_{F}} \frac{{( {α}_{{t}_{n}}^{( k )} - {μ}_{{t}_{n}}^{( k )} )}^{2}}{{( {σ}_{{t}_{n}}^{( k )} )}^{2}} + λ {\int }_{0}^{T} {α}_{t}^{( k )} {α}_{t}^{( k )} d t$$

where:

μₜ_{ₙ}^{(k)} are the components of μₜ_{ₙ}=(μₜ_{ₙ}⁽¹⁾, μₜ_{ₙ}⁽¹⁾, . . . , μₜ_{ₙ}^{(N}^{_{P}}⁾)^{T},

(σₜ_{ₙ}^{(k)})² are the diagonal components of Σₜ_{ₙ}=diag (((σₜ_{₁}^{(k)}))², (σₜ_{ₙ}⁽²⁾)², . . . (σₜ_{ₙ}^{(N}^{_{P}}⁾)²)

[symbol] is a self adjoint differential operator, and

λ is the parameter controlling smoothness of the solution.

The solution to the above-identified equation can be described as:

$${\hat{α}}_{t}^{( k )} = {\sum }_{l = 1}^{{N}_{F}} K ( {t}_{l} , t ) {β}_{l} ,$$

where kernel K(t₁,t₂) is the Green's function of the self-adjoint differential operator L. Kernel K(t₁,t₂) can be described as the Gaussian:

$$K ( {t}_{1} , {t}_{2} ) ∝ {e}^{- \frac{{( {t}_{2} - {t}_{1} )}^{2}}{2 {σ}_{K}^{2}}}$$

The vector of unknown coefficients β=(β₁, β₂, . . . , β_{N}_{_{F}})^{T} that minimizes the right-hand side of the above-mentioned equation after substituting the Gaussian equation for kernel K(t₁,t₂) is the solution to the following system of linear equations:

(K+λS⁻¹)β=μ,

where K is a N_{F}×N_{F} matrix with the elements [K]_{l,m}=K(tₗ,tₘ), S is a N_{F}×N_{F} diagonal matrix

$$S = diag ( {( {σ}_{{t}_{1}}^{( n )} )}^{2} , {( {σ}_{{t}_{2}}^{( n )} )}^{2} , … , {( {σ}_{{t}_{{N}_{F}}}^{( n )} )}^{2} )$$

$$and$$

$$μ = {( {μ}_{{t}_{1}}^{( n )} , {μ}_{{t}_{2}}^{( n )} , … , {μ}_{{t}_{{N}_{F}}}^{( n )} )}^{T} .$$

Accordingly, methods and systems are provided for creating a two-dimensional speech-enabled avatar with realistic facial motion.

In accordance with some embodiments, methods and systems for creating three-dimensional, speech-enabled avatars that provide realistic facial motion from a stereo image are provided. For example, a volumetric display that includes a three-dimensional, speech-enabled avatar can be fabricated. In response to receiving a stereo image with the use of an image acquisition device (e.g., a camera) and a single planar mirror, the three-dimensional avatar of a person's face can be etched into a solid glass block using sub-surface laser engraving technology. The facial animations using the above-described mechanisms can then be projected onto the etched three-dimensional avatar using, for example, a digital projector.

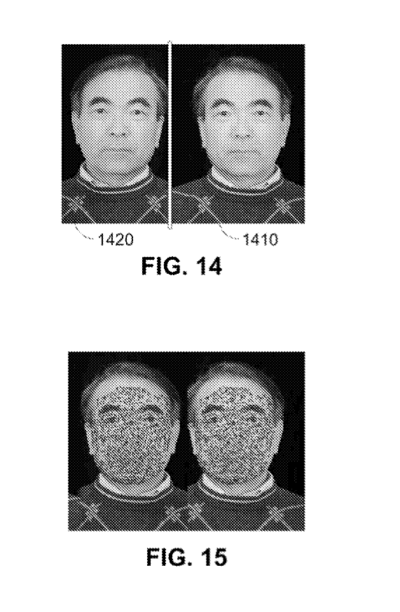

As shown in FIG. 14, an image acquisition device and a single planar mirror can be used to capture a single mirror-based stereo image that includes a direct view of the person's face and a mirror view (the reflection off the planar mirror) of the person's face. The direct and mirror views are considered a stereo pair and subsequently rectified to align the epipolar lines with the horizontal scan lines. Similar to FIGS. 2-4, corresponding points are used to warp the prototype surface to create a facial surface that corresponds to the stereo image. For example, a dense mesh can be generated by warping the prototype facial surface to match the set of reconstructed points. In some embodiments, a number of Harris features in both the direct and mirror views are detected. The detected features in each view are then matched to locations in the second rectified view by, for example, using normalized cross-correlation. In some embodiments, a non-rigid iterative-closes point algorithm is applied to warp the generic mesh. Again, similar to FIGS. 2-4, a number of corresponding points can be manually marked between points on the generic mesh and points on the stereo image. These corresponding points are then used to obtain an initial estimate of the rigid pose and warping of the generic mesh.

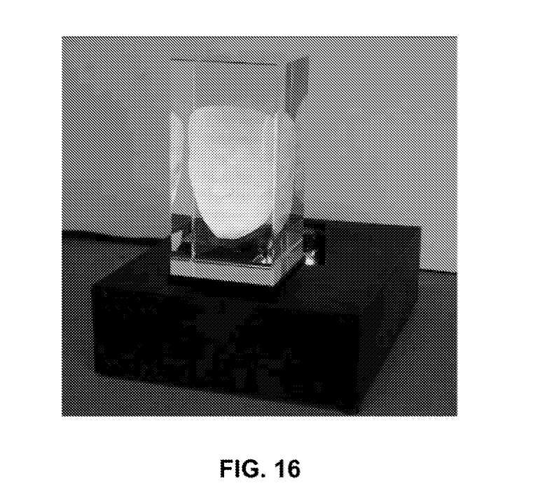

FIG. 16 shows an example of a static three-dimensional shape of a person's face that has been etched into a solid 100 mm×100 mm×200 mm glass block using a sub-surface laser. The estimated shape of a person's face from the deformed prototype surface is converted into a dense set of points (e.g., a point cloud). For example, the point cloud used to create the static face of FIG. 16 contains about one and a half million points.

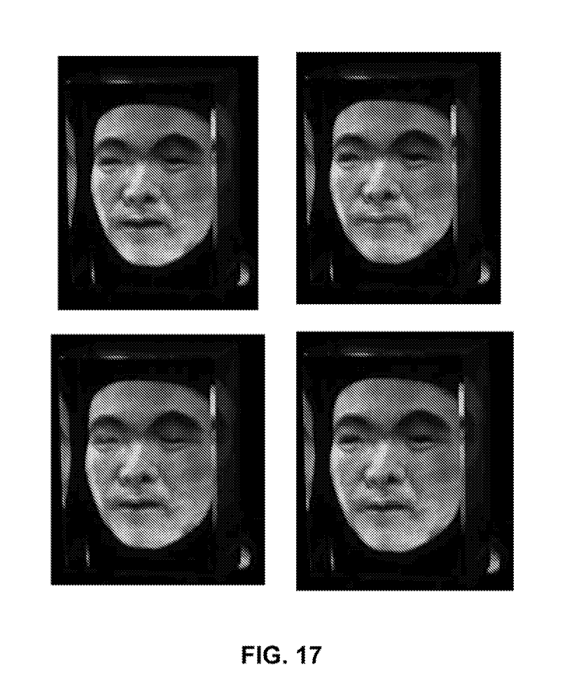

A facial animation video that is generated from text or speech using the approaches described above can be relief-projected onto the static face shape inside the glass block using a digital projection system. FIG. 17 shows examples of the facial animation video projected onto the static face shape at different points in time.

Accordingly, methods and systems are provided for creating a three-dimensional speech-enabled avatar with realistic facial motion.

Although the invention has been described and illustrated in the foregoing illustrative embodiments, it is understood that the present disclosure has been made only by way of example, and that numerous changes in the details of implementation of the invention can be made without departing from the spirit and scope of the invention, which is only limited by the claims which follow. Features of the disclosed embodiments can be combined and rearranged in various ways.

What is claimed is:

1. A method for creating speech-enabled avatars, the method comprising:
receiving a single image that includes a face with a distinct facial geometry;
comparing points on the distinct facial geometry with corresponding points on a prototype facial surface, wherein the prototype facial surface is modeled by a Hidden Markov Model that has facial motion parameters;
deforming the prototype facial surface based at least in part on the comparison;
in response to receiving a text input or an audio input, calculating the facial motion parameters based on a phone sequence corresponding to the received input;
generating a plurality of facial animations based on the calculated facial motion parameters and the Hidden Markov Model; and
generating an avatar from the single image that includes the deformed facial surface, the plurality of facial animations, and the audio input or an audio waveform corresponding to the text input.

2. The method of claim 1, further comprising receiving marked points on the distinct facial geometry and the prototype facial surface.

3. The method of claim 1, further comprising training the Hidden Markov Model with facial motion parameters associated with a training set of motion capture data.

4. The method of claim 1, further comprising training the Hidden Markov Model by supplementing the facial motion parameters with the first derivative of the facial motion parameters and the second derivative of the facial motion parameters.

5. The method of claim 1, wherein the phone sequence is determined from a phone set of distinct phones, the method further comprising training the Hidden Markov Model to account for lexical stress by generating a stressed phone and an unstressed phone for at least one of the distinct phones in the phone set.

6. The method of claim 1, further comprising training the Hidden Markov Model to account for co-articulation by transforming monophones associated with the Hidden Markov Model into triphones.

7. The method of claim 6, further comprising applying a Baum-Welch algorithm to the triphones.

8. The method of claim 1, further comprising obtaining time labels of each phone in the phone sequence.

9. The method of claim 1, further comprising generating the audio waveform and the phone sequence along with corresponding timing information in response to receiving the text input.

10. The method of claim 1, wherein the single image is a stereo image.

11. The method of claim 10, further comprising obtaining the stereo image that includes a direct view and a mirror view using a camera and a planar mirror.

12. The method of claim 10, further comprising:
deforming a three-dimensional prototype facial surface by comparing points on the distinct facial geometry of the stereo image with corresponding points on the prototype facial surface;
converting the deformed three-dimensional prototype facial surface into a plurality of surface points;
etching the plurality of surface points into a glass block; and
projecting the speech-enabled avatar onto the etched plurality of surface points in the glass block.

13. A system for creating speech-enabled avatars, the system comprising:
a processor that:
receives a single image that includes a face with a distinct facial geometry;
compares points on the distinct facial geometry with corresponding points on a prototype facial surface, wherein the prototype facial surface is modeled by a Hidden Markov Model that has facial motion parameters;
deforms the prototype facial surface based at least in part on the comparison;
in response to receiving a text input or an audio input, calculates the facial motion parameters based on a phone sequence corresponding to the received input;
generates a plurality of facial animations based on the calculated facial motion parameters and the Hidden Markov Model; and
generates an avatar from the single image that includes the deformed facial surface, the plurality of facial animations, and the audio input or an audio waveform corresponding to the text input.

14. The system of claim 13, wherein the processor is further configured to receive marked points on the distinct facial geometry and the prototype facial surface.

15. The system of claim 13, wherein the processor is further configured to train the Hidden Markov Model with facial motion parameters associated with a training set of motion capture data.

16. The system of claim 13, wherein the processor is further configured to train the Hidden Markov Model by supplementing the facial motion parameters with the first derivative of the facial motion parameters and the second derivative of the facial motion parameters.

17. The system of claim 13, wherein the phone sequence is determined from a phone set of distinct phones, and wherein the processor is further configured train the Hidden Markov Model to account for lexical stress by generating a stressed phone and an unstressed phone for at least one of the distinct phones in the phone set.

18. The system of claim 13, wherein the processor is further configured to train the Hidden Markov Model to account for co-articulation by transforming monophones associated with the Hidden Markov Model into triphones.

19. The system of claim 18, wherein the processor is further configured to apply a Baum-Welch algorithm to the triphones.

20. The system of claim 13, wherein the processor is further configured to obtain time labels of each phone in the phone sequence.

21. The system of claim 13, wherein the processor is further configured to generate the audio waveform and the phone sequence along with corresponding timing information in response to receiving the text input.

22. The system of claim 13, wherein the single image is a stereo image.

23. The system of claim 22, wherein the processor is further configured to obtain the stereo image that includes a direct view and a mirror view using a camera and a planar mirror.

24. The system of claim 22, wherein the processor is further configured to:
deform a three-dimensional prototype facial surface by comparing points on the distinct facial geometry of the stereo image with corresponding points on the prototype facial surface;
convert the deformed three-dimensional prototype facial surface into a plurality of surface points;
direct a sub-surface laser to etch the plurality of surface points into a glass block; and
direct a digital projector to project the speech-enabled avatar onto the etched plurality of surface points in the glass block.
